(19) United States
(12) Patent Application Publication
(10) Pub. No.: US 2025/0052395 A1
(43) Pub. Date: Feb. 13, 2025

(54) LAMP

(71) Applicant: HYUNDAI MOBIS CO., LTD., Seoul (KR)

(72) Inventors: Hyun Soo LEE, Yongin-si (KR); Sun Kwon MUN, Yongin-si (KR); Na Ram JUN, Yongin-si (KR); Tae Yang PARK, Yongin-si (KR)

(73) Assignee: HYUNDAI MOBIS CO., LTD., Seoul (KR)

(21) Appl. No.: 18/794,306

(22) Filed: Aug. 5, 2024

(30) Foreign Application Priority Data
Aug. 7, 2023 (KR) 10-2023-0103051

(51) Int. Cl. F21S 41/32; F21S 41/24; F21S 41/265; F21S 41/36

(52) U.S. Cl. CPC F21S 41/321; F21S 41/24; F21S 41/265; F21S 41/36

(57) ABSTRACT

Disclosed is a lamp including a first optical module that forms a wide zone of a low beam light distribution pattern, and a second optical module that forms a hot zone of the low beam light distribution pattern having a luminous intensity being higher than a luminous intensity of the wide zone, each of the first optical module and the second optical module includes a light source that outputs light, a light input part, to which the light output from the light source is input, a light output part disposed on a front side of the light input part, and that outputs the light having passed through the light input part, and a guide part disposed between the light input part and the light output part to guide travel of the light having passed through the light input part to the light output part.

### CROSS-REFERENCE TO RELATED APPLICATIONS

This application claims the benefit of priority to Korean Patent Application No. 10-2023-0103051, filed in the Korean Intellectual Property Office on Aug. 7, 2023, the entire contents of which are incorporated herein by reference.

### TECHNICAL FIELD

The present disclosure relates to a lamp.

### BACKGROUND

Various types of vehicle lamps are mounted on vehicles depending on their functions. For example, a low beam lamp, a high beam lamp, and a daytime running light (DRL) lamp are mounted on a front side of a vehicle. Among them, the low beam lamp forms a light distribution pattern having a cutoff line shape at an upper portion thereof.

In detail, the low beam lamp has a primary optical system that collects the light output from a light source, a shield that forms a cutoff shape, and a secondary optical system that focuses on the shield, and outputs the light to a front side to form a light distribution pattern.

About half of the light that passes through this primary optical system is shielded by the shield and cannot be output from the secondary optical system. Accordingly, about half of the light that passes through the primary optical system cannot be used as light for forming a light distribution pattern, and thus, a light output efficiency of the lamp is reduced.

### SUMMARY

The present disclosure has been made to solve the above-mentioned problems occurring in the prior art while advantages achieved by the prior art are maintained intact.

An aspect of the present disclosure provides a lamp that uses most of light that passes a primary optical system as light for forming a light distribution pattern whereby a light output efficiency is improved.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a lamp includes a first optical module that forms a wide zone of a low beam light distribution pattern, and a second optical module that forms a hot zone of the low beam light distribution pattern having a luminous intensity being higher than a luminous intensity of the wide zone, each of the first optical module and the second optical module includes a light source that outputs light, a light input part configured to receive the light output from the light source, a light output part disposed on a front side of the light input part, and that outputs the light passing through the light input part, and a guide part disposed between the light input part and the light output part to guide travel of the light passing through the light input part to the light output part, and when the light input part and the guide part of the first optical module is a first light input part and a first guide part, and the light input part and the guide part of the second optical module is a second light input part and a second guide part, a shape of the first guide part on a side of the first light input part and a shape of the second guide part on a side of the second light input part are different.

Furthermore, a diameter of the first light input part may be smaller than a diameter of the second light input part.

Furthermore, a first light input groove recessed to a front side may be formed on a rear side of the first light input part, a second light input groove recessed to a front side may be formed on a rear side of the second light input part, and a diameter of the first light input groove may be smaller than a diameter of the second light input groove.

Furthermore, an upward/downward height of a lower end of the first light input part may be equal to or greater than an upward/downward height of a first light output optical axis being an optical axis of a first light output part being the light output part of the first optical module, and a center of the first light input part may be located between an upper end of the first light output part and the first light output optical axis.

Furthermore, the first light input optical axis being an optical axis of the first light input part may be formed to be inclined to a front side and a lower side with respect to the first light output optical axis, and may pass through a focus of the light output part.

Furthermore, the first optical module may include a first reflection area disposed between the first light input part and a first light output part being the light output part of the first optical module with respect to a forward/rearward direction, and that reflects a portion of the light passing through the first light input part, and a first extension surface extending between a rear end of the first reflection area and a lower end of the first light input part.

Furthermore, the first extension surface may extend from the rear end of the first reflection area to a rear side to be inclined to a lower side with respect to a first light input optical axis being an optical axis of the first light input part.

Furthermore, when an optical axis of the first light output part is a first light output optical axis, an angle formed by the first light output optical axis and the first extension surface may be smaller than an angle formed by the first light output optical axis and the first light input optical axis.

Furthermore, when an optical axis of the second light input part is a second light input optical axis, and an optical axis of a second light output part being the light output part of the second optical module is a second light output optical axis, the second light input optical axis and the second light output optical axis may be formed to be parallel to each other.

Furthermore, when the light output part of the second optical module is a second light output part, the second optical module may further include a second reflection area disposed between the second light input part and the second light output part with respect to a forward/rearward direction, and that reflects a portion of the light passing through the second light input part, and a second extension surface extending between a rear end of the second reflection area and a lower end of the second light input part, a second light output optical axis being an optical axis of the second light output part may extend along a forward/rearward direction, and the second extension surface may extend to a lower side and a rear side with respect to the second light output optical axis, and may be disposed to overlap the second light input part along the forward/rearward direction.

Furthermore, a first brightness being a maximum brightness of the light passing through the first light input part may be smaller than a second brightness being a maximum brightness of the light passing through the second light input part.

Furthermore, when the light source and the light output part of the first optical module are a first light source and a first light output part, respectively, the first light input part may include a first light input central part that refracts a first central light being a portion of the light output from the first light source such that the first central light travels toward a focus of the first light output part, when the light source and the light output part of the second optical module are a second light source and a second light output part, respectively, the second light input part may include a second light input central part that refracts a second central light being any portion of the light output from the second light source such that the second central light travels toward a focus of the second light output part, and a first distance being a spacing distance between the first light input central part and the first light source may be smaller than a second distance being a spacing distance between the second light input central part and the second light source.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a lamp according to a first embodiment of the present disclosure;

FIG. 2 is a longitudinal cross-sectional view of a light output part according to a first embodiment of the present disclosure;

FIG. 3 is a longitudinal cross-sectional view of a lamp according to a first embodiment of the present disclosure;

FIG. 4 is a view illustrating a light input part provided with an aspheric lens; FIG. 5 is a view illustrating the light input part provided with a TIR lens;

FIG. 6 is a view illustrating a light source and a light input part arranged along an upward/downward direction;

FIG. 7 is a longitudinal cross-sectional view of a lamp according to a first modification of the present disclosure;

FIG. 8 is a longitudinal cross-sectional view of a lamp according to a second embodiment of the present disclosure;

FIG. 9 is a longitudinal cross-sectional view of a lamp according to a second modification of the present disclosure;

FIG. 10 is a longitudinal cross-sectional view of a first optical module according to a third embodiment of the present disclosure;

FIG. 11 is a longitudinal cross-sectional view of a second optical module according to a third embodiment of the present disclosure;

FIG. 12 is a longitudinal cross-sectional view of a lamp according to a fourth embodiment of the present disclosure; and

FIG. 13 is a transverse cross-sectional view of a lamp according to a fifth embodiment of the present disclosure.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. When it is described that a certain component is “input to”, “passes through” or “output from” a second component, it should be understood that the component may be directly input to, passes through, or output from the second component, but a third component may be “input” or “pass”, or “output” between the components.

### First Embodiment

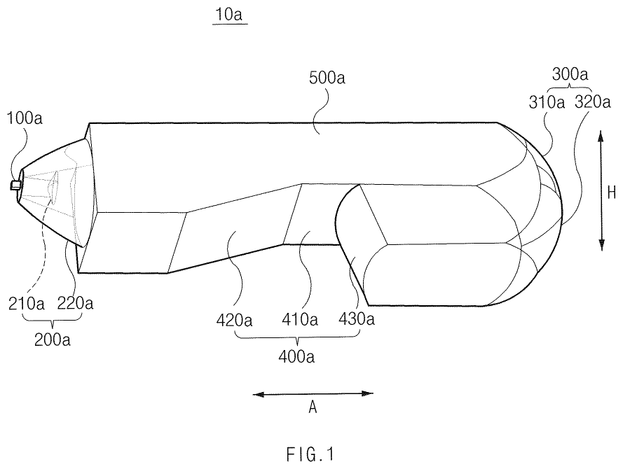

Hereinafter, a lamp 10a according to a first embodiment of the present disclosure will be described with reference to FIGS. 1 to 6.

Referring to FIG. 1, the lamp 10a may be a vehicle lamp that is provided in a vehicle. For example, the lamp 10a may be a headlamp that is provided on both left and right sides of a front side of the vehicle. The lamp 10a may form a low beam light distribution pattern to ensure a visibility of a driver. The low beam light distribution pattern may include a cutoff line, a hot zone, and a wide zone. The cutoff line may define an upper end of the low beam light distribution pattern. The hot zone may define a central portion of the low beam light distribution pattern. Furthermore, the wide zone may define a peripheral portion of the light distribution pattern, which surrounds the hot zone, and may have a luminous intensity that is lower than that of the hot zone. The lamp 10a may include a light source 100a, a light input part 200a, a light output part 300a, a shield part 400a, and a guide part 500a.

The light source 100a may output light. As an example, the light source 100a may be a light emitting diode (LED). The light output from this light source 100a may be spread around a light source optical axis 100x. The light source optical axis 100x may mean an optical axis of the light source 100a. The light source optical axis 100x may be defined as an imaginary straight line that passes or extends through a center of the light source 100a and extends along a travel direction of the output light. The light source optical axis 100x may be formed to be inclined toward a front side and a lower side with respect to a forward/rearward direction “A”.

The light emitted from the light source 100a may be input to the light input part 200a. The light that passed through the light input part 200a may be input to the guide part 500a. The light input to the guide part 500a may travel toward a focus of the light output part 300a. In other words, the light input to the guide part 500a may be condensed at a focus of the light output part 300a.

The light input part 200a may be disposed on a front side of the light source 100a. Furthermore, as an example, the light input part 200a may be spaced apart from the light source 100a. Furthermore, a front end of the light input part 200a may be attached to a rear end of the guide part 500a. In other words, the light input part 200a may be disposed between the light source 100a and the guide part 500a with respect to the forward/rearward direction “A”.

A light input groove that is recessed to a front side may be formed in the light input part 200a. The light output from the light source 100a may pass through the light input groove, and then may reach a light input area that is an area that surrounds the light input groove. The light that reached the light input area may be refracted in the light input area.

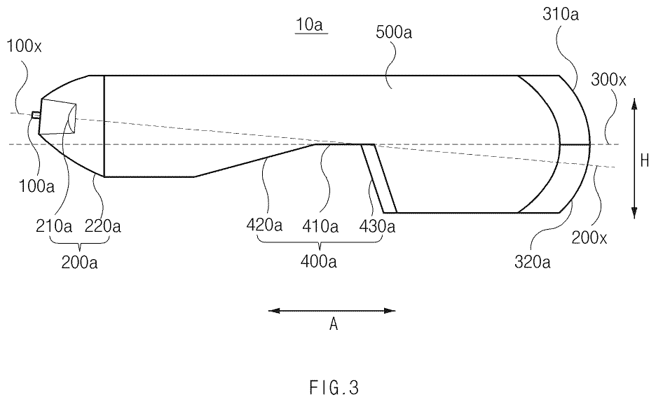

Referring back to FIG. 3, a light input optical axis 200x that is an optical axis of the light input part 200a may be formed in parallel to a light source optical axis 100x. The light input optical axis 200x may be defined as an imaginary straight line that passes through a center of the light input part 200a and a focus of the light output part 300a. Furthermore, the focus of the light output part 300a may be disposed on an upper side of a front end of a reflection area 410a that will be described later.

The features of the light source 100a, the light input part 200a, the light output part 300a, the shield part 400a, and the guide part 500a described in the specification may be understood as features that may satisfy geometric characteristics, in which the light input optical axis 200x passes or extends through a center of the light input part 200a and a focus of the light output part 300a.

Furthermore, the geometric characteristics of the light source optical axis 100x, the light input optical axis 200x, and a light output optical axis 300x in the specification may be satisfied by a combination of at least some of the configurations according to first to fifth embodiments in the specification, and the satisfaction is not limited to a combination of the configurations according to any one embodiment.

In detail, any one of light sources 100a, 100b, 100c1, 100c2, 100d, and 100e, any of light input parts 200a, 200a′, 200a″, 200a″′, 200b, 200c1, 200c2, 200d, and 200e, any one of light output parts 300a, 300b, 300c1, 300c2, 300d, and 300e, any one of shield parts 400a, 400b, 400c1, 400c2, and 400d, and any one of guide parts 500a, 500b, 500c1, 500c2, 500d, and 500e that are components according to the first to fifth embodiments in the specification may be combined with each other, and only the components of any one embodiment are not combined in a limited way.

The light input optical axis 200x and the light output optical axis 300x may be nonparallel to each other. The light output optical axis 300x may mean an optical axis of the light output part 300a. For example, the light input optical axis 200x may be an imaginary straight line that extends to be inclined to a front side and a lower side with respect to the light output optical axis 300x.

In other words, when the lamp 10a is viewed in the leftward/rightward direction, the light input optical axis 200x and the light output optical axis 300x may cross each other at one point. As a detailed example, the light input optical axis 200x and the light output optical axis 300x may cross each other on an upper side of a front end of the reflection area 410a.

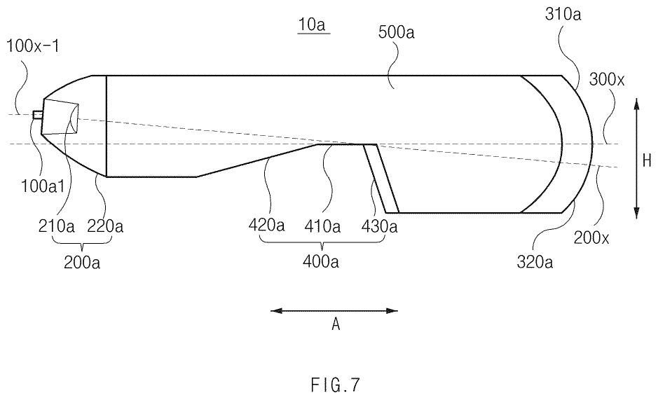

Meanwhile, the idea of the present disclosure is not limited thereto, and according to the first modification of the present disclosure, the light input optical axis 200x and a light source optical axis 100x-1 may be nonparallel to each other. Referring to FIG. 7, the light source optical axis 100x-1 may be formed in parallel to a forward/rearward direction “A”. In other words, when the lamp 10a is viewed in the leftward/rightward direction, the light source optical axis 100x-1 and the light input optical axis 200x may cross each other at one point. Furthermore, the light source optical axis 100x-1 may be disposed in parallel to the light output optical axis 300x.

In this way, when the light source optical axis 100x-1 is formed in parallel to the forward/rearward direction “A”, a heat sink (not illustrated), on which the light source 100a is seated, may be oriented not to be inclined with respect to the forward/rearward direction “A”. As an example, the heat sink may be disposed on a rear side of the light source 100a.

Furthermore, a front end of a reflection area 410b may be disposed on a lower side of the focus of the light output part 300a, or may be located at the same height as that of the focus.

The light input part 200a may include a light input central part 210a and a light input outskirt part 220a.

The light input to the light input central part 210a may be refracted in the light input central part 210, and then may travel to the focus of the light output part 300a. The light input central part 210a may define a central portion of the light input part 200a. The light input central part 210a may be disposed to face the light source 100a. The light input central part 210a may have a shape that is convex to a rear side. The rear side of the light input central part 210a may define a front side of the light input area.

The light input to the light input outskirt part 220a may be totally reflected in the light input outskirt part 220a, and then may travel to the focus of the light output part 300a. For example, the light may be input to the inner area of the light input outskirt part 220a, and the light may be totally reflected in the outer area of the light input outskirt part 220a. An inner area of the light input outskirt part 220a may define an inner peripheral surface of the light input area. For example, the inner area of the light input outskirt part 220a may extend from a rear side of the light input central part 210a to a rear side. Furthermore, an outer area of the light input outskirt part 220a may extend from a rear end of the inner area of the light input outskirt part 220a to a front side.

The light that passed through the inner area of the light input outskirt part 220a may be refracted, and then may reach the outer area of the light input outskirt part 220a. The light input outskirt part 220a may define an outskirt part of the light input part 200a. The light input outskirt part 220a may have a shape that surrounds the light input central part 210a.

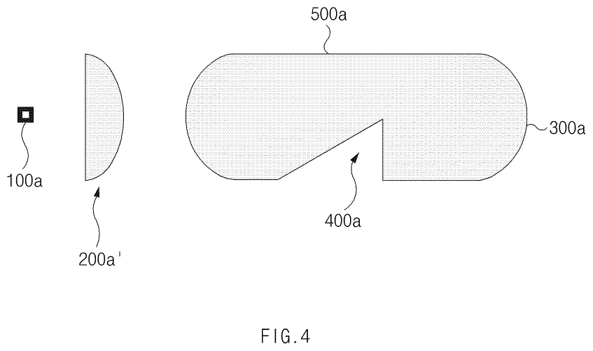

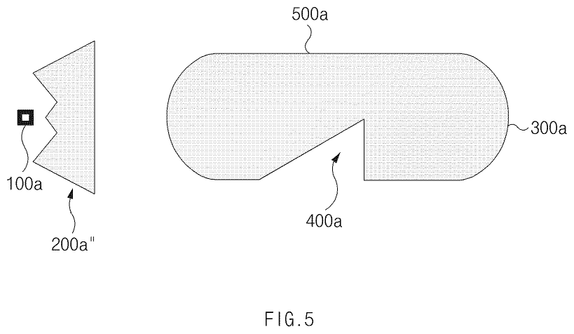

Meanwhile, the light input part 200a according to the first embodiment of the present disclosure is not limited to the above-described contents, and referring to FIGS. 4 and 5, light input parts 200a′ and 200a″ according to embodiments that are different from the first embodiment may be provided as collimators. The collimator may form parallel light (for example, light that is parallel to the forward/rearward direction).

The light input parts 200a′ and 200a″ may be disposed between the light source 100a and the guide part 500a with respect to the forward/rearward direction “A”. Furthermore, the light input parts 200a′ and 200a″ may be disposed to be spaced apart from the guide part 500a.

For example, referring to FIG. 4, the light input part 200a′ may have a shape of an aspheric lens. As another example, referring to FIG. 5, the light input part 200a″ may have a shape of a total internal reflection (TIR) lens. The TIR lens may be named ‘a total reflection lens’.

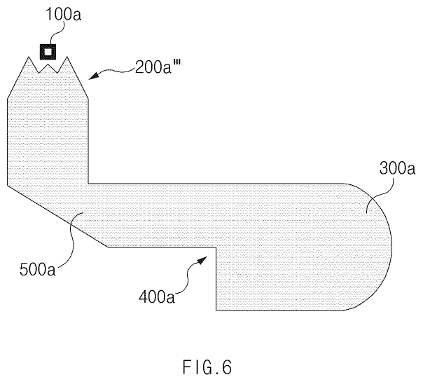

Meanwhile, the light input part 200a′ and 200a′ according to the embodiments that are different from the first embodiment of the present disclosure are not limited to the above-described contents, and referring to FIG. 6, a light input part 200a″′ according to the embodiments that are different from the first embodiment may be oriented along an upward/downward direction “H”.

The light input part 200a″′ and the light source 100a may be arranged to be spaced apart from each other along the upward/downward direction “H”. For example, the light input part 200a″′ may be disposed on a lower side of the light source 100a. Furthermore, the light input part 200a″′ may be attached to an upper end of the guide part 500a.

The guide part 500a according to the first and other embodiments may include an upward/downward guide area, a reflection guide area, and a forward/rearward guide area. The upward/downward guide area may extend from the light input part 200a″′ to a lower side. The reflection guide area may extend from a lower end of the upward/downward guide area to a front side. In the reflection guide area, the light that passed through the light input part 200a″′ may be reflected, and may travel toward the shield part 400a. The forward/rearward guide area may extend from a front end of the reflection guide area to the light output part 300a along the forward/rearward direction “A”.

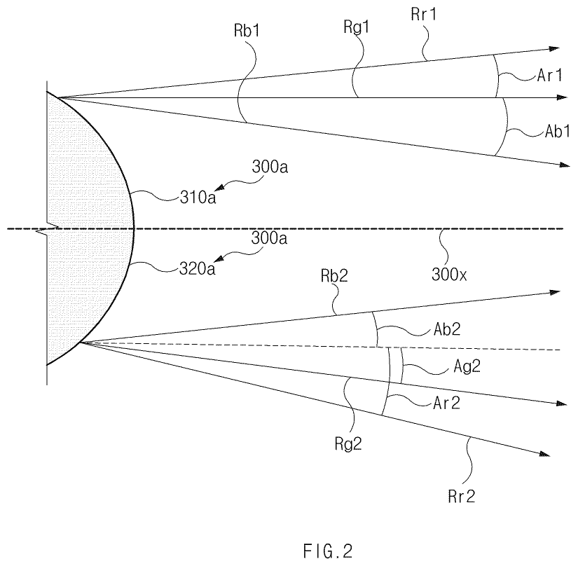

Referring back to FIG. 2, the light that passed through the guide part 500a may be output from the light output part 300a to an outside of the lamp 10a. The light output from the light output part 300a may travel to a front side. The light output part 300a may be disposed on a front side of the guide part 500a. The light output part 300a may have a shape that is convex to a front side. As an example, the light output part 300a may be an aspheric lens. The light output part 300a may include an upper light output area 310a and a lower light output area 320a.

The upper light output area 310a may define an upper portion of the light output part 300a. For example, the upper light output area 310a may mean an area of the light output part 300a, which is located on an upper side of the light output optical axis 300x. The light output from the upper light output area 310a may be named ‘an upper light’. A curvature of the upper light output area 310a in the upward/downward direction “H” may be named a first curvature.

The upper light output area 310a may have a shape that is symmetrical in the leftward/rightward direction. Furthermore, the upper light output area 310a may have a shape that is rotationally symmetrical with respect to the light output optical axis 300x. For example, when a right area (an area that defines a right side of the upper light output area 310a) of the upper light output area 310a is rotated about the light output optical axis 300x by a specific angle, the right area of the rotated upper light output area 310a may completely overlap a left area of the upper light output area 310a (an area that defines a left side of the upper light output area 310a) that is not rotated.

The lower light output area 320a may define a lower portion of the light output part 300a. For example, the lower light output area 320a may mean an area of the light output part 300a, which is located on a lower side of the light output optical axis 300x. The light output from the lower light output area 320a may be named ‘a lower light’. A curvature of the lower light output area 320a in the upward/downward direction “H” may be named a second curvature.

The lower light output area 320a may have a shape that is symmetrical in the leftward/rightward direction. Furthermore, the lower light output area 320a may have a shape that is rotationally symmetrical with respect to the light output optical axis 300x. For example, when a right area (an area that defines a right side of the lower light output area 320a) of the lower light output area 320a is rotated around the light output optical axis 300x by a specific angle, a right area of the rotated lower light output area 320a may completely overlap a left area of the lower light output area 310a (an area that defines a left side of the lower light output area 320a) that is not rotated. The first curvature and the second curvature may be different from each other. For example, when the lights having the same wavelength are output from the upper light output area 310a and the lower light output area 320a, respectively, a degree of refraction may be different. As another example, an upper light output focus that is a focus of the upper light output area 310a and a lower light output focus that is a focus of a lower light output area 320d may be different from each other.

The upper light output focus may be located on the light output optical axis 300x. Furthermore, the lower light output focus may be located on a rear side of the upper light output focus. For example, when parallel light that travels toward a rear side is input to the lower light output area 320a from an outside, the parallel light input to the lower light output area 320d may pass through an area located on a rear side of the upper light output focus.

Furthermore, when the first curvature and the second curvature are different, as an example, a step may be formed in a connection area that is an area, in which the upper light output area 310a and the lower light output area 320a are connected to each other.

As another example, when no step is formed in the connection area, the upper light output area 310a has a shape that is symmetrical in the leftward/rightward direction and is rotationally symmetrical with respect to the light output optical axis 300x, and the lower light output area 320d may have a shape that is symmetrical in the leftward/rightward direction and is not rotationally symmetrical with respect to the light output optical axis 300x. However, the description of the shapes of the upper light output area 310a and the lower light output area 320a corresponds to an exemplary description, and the idea of the present disclosure is not necessarily limited to the examples.

The first curvature may be greater than the second curvature. In other words, a degree of bending of the upper light output area 310a with respect to the upward/downward direction “H” may be greater than a degree of bending of the lower light output area 320a. That is, a radius of curvature of the upper light output area 310a in the upward/downward direction “H” may be smaller than a radius of curvature of the lower light output area 320a in the upward/downward direction “H”.

For example, with reference to the lights having the same wavelength, a degree of refraction of the light output from an upper reference point is refracted may be greater than a degree of refraction of the light output from a lower reference point. For example, the light output from the upper reference point may be refracted to be inclined toward a lower side with respect to a travel direction of the input light. Furthermore, the light output from the lower reference point may be refracted to be inclined toward an upper side with respect to the travel direction of the input light.

The upper reference point may mean an arbitrary point of the upper light output area 310a, which is spaced apart from the light output optical axis 300x to an upper side, and the lower reference point may mean an arbitrary point of the lower light output area, which is spaced apart from the light output optical axis 300x to a lower side. Furthermore, the upper reference point and lower reference point may be positioned at positions that are perpendicular to the upward/downward direction “H” and are symmetrical to each other with respect to the imaginary plane that passes or extends through the light output optical axis 300x. That is, a spacing distance between the upper reference point and the imaginary plane in the upward/downward direction “H” may be the same as a spacing distance between the lower reference point and the imaginary plane in the upward/downward direction “H”.

Furthermore, an angle formed by the light input to the upper reference point and the light output optical axis 300x may be the same as an angle formed by the light input to the lower reference point and the light output optical axis 300x.

Referring back to FIG. 2, among the lights output from the upper reference point, the light having a first wavelength, the light having the second wavelength, and the light having the third wavelength may be named a first upper wavelength light Rr1, a second upper wavelength light Rb1, and a third upper wavelength light Rg1, respectively.

Furthermore, among the lights output from the lower reference point, the light having the first wavelength, the light having the second wavelength, and the light having the third wavelength may be named a first lower wavelength light Rr2, a second lower wavelength light Rb2, and a third lower wavelength light Rg2, respectively.

For example, the light having the first wavelength may be observed as red by the user. For example, the first wavelength may be 630 nm or more and 780 nm or less.

Furthermore, as an example, the light having the second wavelength may be observed as blue by the user. The second wavelength may be shorter than the first wavelength. As an example, the second wavelength may be 380 nm or more and 420 nm or less.

Furthermore, as an example, the light having the third wavelength may be observed as green. The third wavelength may be shorter than the first wavelength and longer than the second wavelength. As an example, the third wavelength may be greater than 420 nm and less than 630 nm.

Furthermore, a first upper wavelength angle Ar1 that is an angle formed by the first upper wavelength light Rr1 and the light output optical axis 300x may be smaller than a first lower wavelength angle Ar2 that is an angle formed by the first lower wavelength light Rr2 and the light output optical axis 300x.

Furthermore, a second upper wavelength angle Ab1 that is an angle formed by the second upper wavelength light Rb1 and the light output optical axis 300x may be larger than a second lower wavelength angle Ab2 that is an angle formed by the second lower wavelength light Rb2 and the light output optical axis 300x.

Furthermore, a third upper wavelength angle that is an angle formed by the third upper wavelength light Rg1 and the light output optical axis 300x may be smaller than a third lower wavelength angle Ag2 that is an angle formed by the third lower wavelength light Rg2 and the light output optical axis 300x. Furthermore, as an example, the third upper wavelength angle may be 0 degrees. In other words, the third upper wavelength light Rg1 and the light output optical axis 300x may be parallel to each other.

A portion of the upper light, which has the first wavelength, and a portion of the lower light, which has the second wavelength may form a cutoff line. For example, a portion of the upper light, which has the first wavelength, may be the first upper wavelength light Rr1, and a portion of the lower light, which has the second wavelength, may be the second lower wavelength light Rb2. As a more detailed example, the first upper wavelength light Rr1 may be red light and the second lower wavelength light Rb2 may be blue light, and the red light and the blue light may overlap each other at the cutoff line.

In this way, as light components having different wavelengths overlap each other at the cutoff line through the difference between the first curvature and the second curvature, a prominent appearance of light of a specific wavelength at the cutoff line due to chromatic aberration may be minimized. In other words, due to chromatic aberration of the light components having different wavelengths, the cutoff line that is observed as purple or blue to the user may be minimized whereby a light distribution pattern with a chromaticity that satisfies the laws may be implemented.

The shield part 400a may prevent a portion of the light that passed through the light input part 200a from traveling to a front side. As an example, the shield part 400a may have a shape that is recessed into an upper side. Furthermore, the shield part 400a may be disposed between the light input part 200a and the light output part 300a with respect to the forward/rearward direction “A”. The shield part 400a may include a first area 410a, a second area 420a, and a third area 430a.

The first area 410a may reflect the first light that is any portion of the light that passed through the light input part 200a. For example, the first light may be reflected from an upper surface of the reflection area 410a. The first light reflected from the first area 410a may be output from the upper light output area 310a. The first area 410a may be named ‘a reflection area 410a’.

The second area 420a may extend from a rear end of the first area 410a to a rear side. For example, the second area 420a may extend obliquely a rear side to be inclined toward a lower side with respect to the light output optical axis 300x. After passing through the light input part 200a, the light that reached the second area 420a is reflected to an upper side, and may be prevented from moving to a front side. The second area 420a may be named ‘a light shielding area 420a’.

The third area 430a may extend from a front end of the first area 410a to a lower side. For example, the third area 430a may extend obliquely to a lower side to be inclined from a front end of the first area 410a to a front side. When the third area 430a is cut in the upward/downward direction “H”, the third area 430a may have a shape of a straight line. However, the present disclosure is not limited to the example, and when the third area 430a is cut in the upward/downward direction “H”, the third area may have a curved shape that is convex to a rear side.

The guide part 500a may guide travel of the light that passed through the light input part 200a to the light output part 300a. The guide part 500a may be disposed between the light input part 200a and the light output part 300a with respect to the forward/rearward direction “A”. For example, a rear end of the guide part 500a may be connected to a front end of the light input part 200a, and a front end of the guide part 500a may be connected to the light output part 300a. Furthermore, the light input part 200a, the light output part 300a, the shield part 400a, and guide part 500a may be integrally formed. The light input part 200a, the light output part 300a, the shield part 400a, and the guide part 500a may be one lens that is integrally formed.

### Second Embodiment

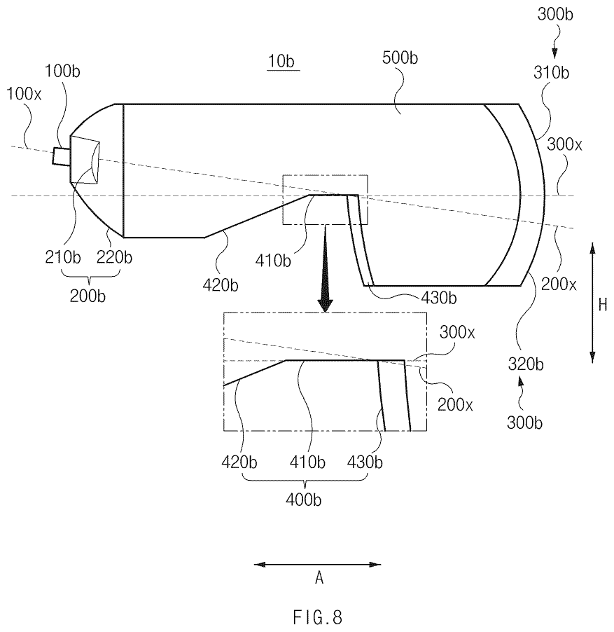

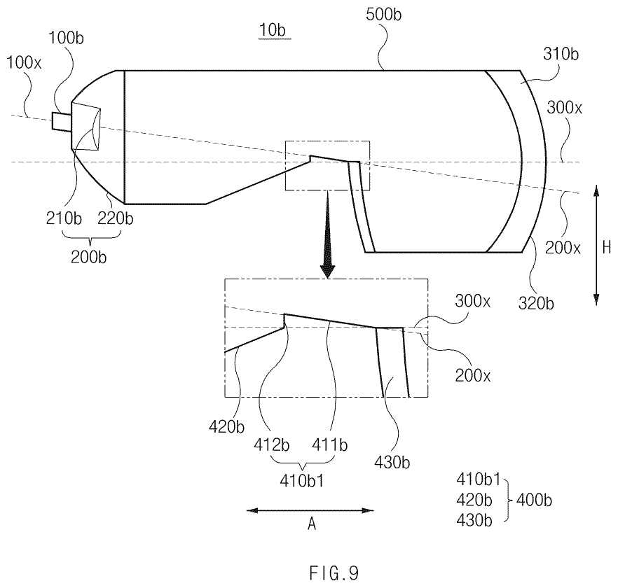

Hereinafter, a lamp 10b according to the second embodiment of the present disclosure will be described with reference to FIGS. 8 and 9. In a description of the lamp 10b according to the second embodiment, a difference from the lamp 10a according to the first embodiment in the present disclosure is mainly described.

The lamp 10b according to the second embodiment of the present disclosure may include a light source 100b, a light input part 200b, a light output part 300b, a shield part 400b, and a guide part 500b. Meanwhile, for the contents regarding the light source 100b, the light input part 200b, the light output part 300b, and the guide part 500b according to the second embodiment of the present disclosure, the description of the light source 100a, the light input part 200a, the light output part 300a, and the guide part 500a according to the first embodiment of the present disclosure is used.

Furthermore, the light input part 200b may include a light input central part 210b and a light input outskirt part 220b. Furthermore, the light output part 300b may include an upper light output area 310b and a lower light output area 320b. For the description of the light input central part 210b, the light input outskirt part 220b, the upper light output area 310b, and the lower light output area 320b according to the second embodiment of the present disclosure, the description of the light input central part 210a, the light input outskirt part 220a, the upper light output area 310a, and the lower light output area 320a according to the first embodiment of the present disclosure is used.

The shield part 400b may include a first area 410b, a second area 420b, and a third area 430b. Meanwhile, for the contents regarding the second area 420b and the third area 430b according to the second embodiment of the present disclosure, the description of the second area 420a and the third area 420b according to the first embodiment of the present disclosure is used.

Referring to FIG. 8, the first area 410b may be named ‘a reflection area 410b’. The reflection area 410b may extend in parallel to the forward/rearward direction “A”. Furthermore, the reflection area 410b may overlap the light output optical axis 300x. In other words, as an example, a height of the reflection area 410b in the upward/downward direction “H” may be equal to or smaller than a height of the light output optical axis 300x.

For example, when a height of the reflection area 410b in the upward/downward direction “H” is smaller than a height of the light output optical axis 300x, the reflection area 410b may be spaced apart from the light output optical axis 300x in the upward/downward direction “H”. As another example, when a height of the reflection area 410b in the upward/downward direction is the same as a height of the light output optical axis 300x, the reflection area 410b may overlap the light output optical axis 300x.

The reflection area 410b may be disposed on a lower side of the light source 100a. Furthermore, the reflection area 410b may be disposed on a lower side of the center of the light input part 200a.

In this way, as the reflection area 410b is parallel to the forward/rearward direction “A”, an angle formed by the light that reached the reflection area 410b and the light output optical axis 300x may be the same as an angle formed by the light reflected by the reflection area 410b and the light output optical axis 300x.

For example, the reflection introduction angle and the reflection angle may be the same. The reflection introduction angle may be defined as an angle formed by the light output optical axis 300x and an imaginary straight line that extends in a reflection introduction direction. Furthermore, the reflection angle may be defined as an angle formed by the light output optical axis 300x and an imaginary straight line that extends in a reflection direction.

The reflection introduction direction may be defined as a travel direction of the first ray before the first ray reaches the reflection area 410b. The reflection direction may be defined as a travel direction of the first ray that is reflected in the reflection area 410b. The first ray may mean that any portion of the light output from the light output part 300a.

Meanwhile, the idea of the present disclosure is not limited thereto, and referring to FIG. 9, the first area 410b1 according to a second modification of the present disclosure may include a reflection area 411b and an extension area 412b.

Furthermore, the reflection area 411b may extend in nonparallel to the light output optical axis 300x. For example, the reflection area 411b may extend obliquely to a rear side to be inclined to an upper side with respect to the light output optical axis 300x.

For example, when the lamp 10b is viewed in the leftward/rightward direction, the reflection area 411b and the light output optical axis 300x may form a specific angle. An angle formed by the reflection area 411b and the light output optical axis 300x may be greater than 0 degrees and not more than 5 degrees. Furthermore, as an example, an angle formed by the light input optical axis 200x and the light output optical axis 300x may be the same as an angle formed by the reflection area 411b and the output area 213b.

A height of a front end of the reflection area 411b may be disposed to be the same as a height of the light output optical axis 300x in the upward/downward direction “H”. Furthermore, a rear end of the reflection area 411b may be disposed on an upper side of the light output optical axis 300x. Due to the reflection area 411b, the reflection angle may be smaller than the reflection introduction angle.

Furthermore, the reflection angle may be smaller than a reference angle. The reference angle may be defined as an angle that is formed by a reference line that passes or extends through an upper end of the light output part 300a and a front end of the reflection area 411b, and the light output optical axis 300x when the lamp is viewed in the leftward/rightward direction. In this way, because the reflection angle is smaller than the reference angle, the reflection angle may be prevented from becoming excessively large. In this way, because the reflection angle is not formed to be excessively large, the reflected light reaches a rear side of the light output part 300a whereby the light may be prevented from being totally reflected by the light output part 300a. Furthermore, because the reflection angle is not formed to be excessively large, a light output efficiency of the lamp 10b may be improved by maximizing an amount of the light that reaches the light output part 300a.

Furthermore, the extension area 412b may extend from a rear end of the reflection area 411b to a lower side. Furthermore, a lower end of the extension area 412b may be connected to a front end of the second area 420b. In other words, the extension area 412b may extend along the upward/downward direction “H” between the rear end of the reflection area and the front end of the second area 420a. The second area 420b may be named ‘a light shielding area 420b’.

### Third Embodiment

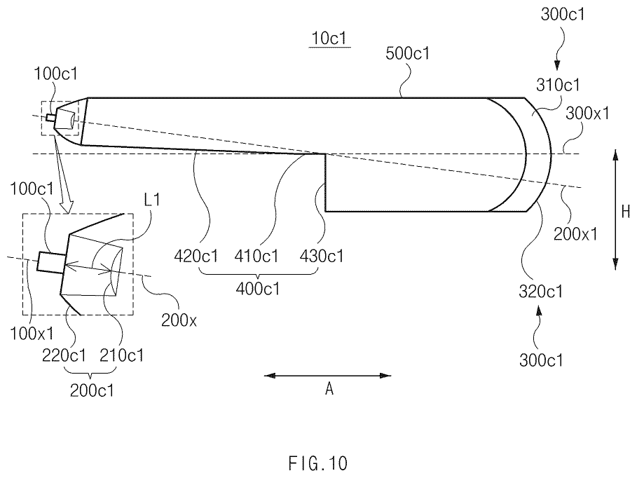

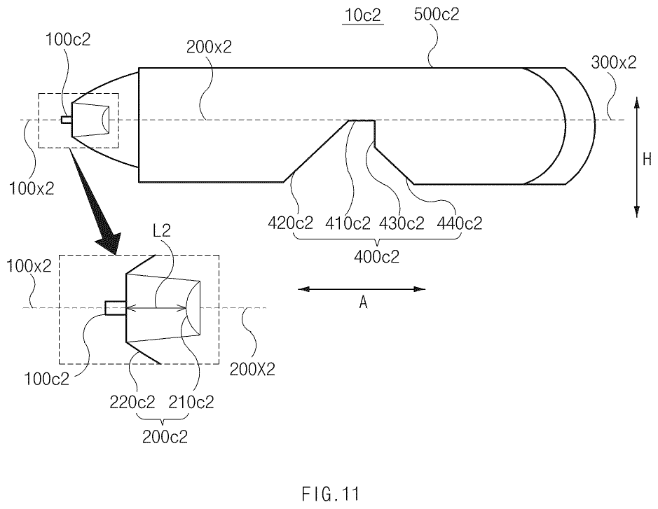

Hereinafter, lamps 10c1 and 10c2 according to the third embodiment of the present disclosure will be described with reference to FIGS. 10 and 11. The lamps 10c1 and 10c2 may include a first optical module 10c1 and a second optical module 10c2.

Referring to FIG. 10, the first optical module 10c1 may form a wide zone of a low beam light distribution pattern. Meanwhile, the present disclosure is not limited to the example, and the first optical module 10c1 may form an entire low beam light distribution pattern.

The first optical module 10c1 includes a first light source 100c1, a first light input part 200c1, a first light output part 300c 1, a first shield part 400c1, and a first guide part 500c1. For the description of the first light output part 300c1 and the first guide part 500c1 according to the third embodiment of the present disclosure, the description of the light output part 300a and the guide part 500a according to the first embodiment of the present disclosure is used.

The first light output part 300c1 may include a first upper light output area 310c1 and a first lower light output area 320c1. For the description of the first upper light output area 310c1 and the first lower light output area 320c1 according to the third embodiment of the present disclosure, the description of the upper light output area 310a and the lower light output area 320a according to the first embodiment is used.

A height of a lower end of the first light input part 200c1 in the upward/downward direction “H” may be equal to or greater than a height of the first light output optical axis 300x1 in the upward/downward direction. The first light output optical axis 300x may mean an optical axis of the first light output part 300c1.

A center of the first light input part 200c1 may be located between an upper end of the light output part 300a and the light output optical axis 300x with respect to the upward/downward direction “H”. Furthermore, a width of the first light input part 200c1 in the upward/downward direction “H” may be smaller than a width of the first light output part 300c1 in the upward/downward direction “H”. For example, a width of the first light input part 200c1 in the upward/downward direction “H” may be equal to or greater than a width of the first upper light output area 310c1 in the upward/downward direction “H”. The first upper light output area 310a may form an upper portion of the first light output part 300c1. Furthermore, with respect to the forward/rearward direction “A”, the first light input part 200c1 may be disposed to face the first upper light output area 310c1.

The first light input optical axis 200x1 that is an optical axis of the first light input part 200c1 may be formed in parallel to the light source optical axis 100x1 that is an optical axis of the first light source 100c1. Furthermore, the first light input optical axis 200x1 may be defined as an imaginary straight line that passes or extends through a front end of the first reflection area 410c1 and a center of the first light input part 200c1. Furthermore, the first light input optical axis 200x1 may extend obliquely to be inclined to a front side and a lower side with respect to the first light output optical axis 300x1. The first light output optical axis 300x1 may mean an optical axis of the first light output part 300c1. The first light output optical axis 300x1 may be parallel to the forward/rearward direction “A”. The first light input part 200c1 may include a first light input central part 210c1 and a first light input outskirt part 220c1.

A distance between the first light input central part 210a and the first light source 100a may be named a first distance L1. For example, the first distance L1 may correspond to a depth of the first light input groove that is a light input groove of the first light input part 200c1.

The first light input groove may have a shape that is recessed to a front side on a rear side of the first light input part 200c1. The first light input groove may be a groove that is surrounded by an area, in which the light output from the first light source 100c1 of the first light input part 200c1 is input.

The first shield part 400c1 may include a first area 410c1, a second area 420c1, and a third area 430c1. For the description of the first area 410c1 according to the third embodiment of the present disclosure, the description of the first area 410b according to the second embodiment of the present disclosure is used. The first area 410c1 may be named ‘a first reflection area 410c1’.

The second area 420c1 may be a surface that extends between a rear end of the first reflection area 410c1 and a lower end of the first light input part 200c1. The second area 420c1 may be named ‘an extension surface 420c1’. A “H” height of the first reflection area 411b in the upward/downward direction may be equal to or greater than a height of a lower end of the first light input part 200c1 in the upward/downward direction “H”. In this way, when the first light input part 200c1 is disposed on an upper side of the reflection area 411b, the light that passed through a lower portion of the first light input part 200c1 may not be shielded by the first shield part 400c1 and may be output from the first light output part 300c1. In other words, because all the light that passed through the first light input part 200c1 is output from the first light output part 300c1, an amount of the light output from the first optical module 10c1 is maximized. In this way, because the amount of the light output from the first optical module 10c1 is maximized, an output efficiency of the first optical module 10c1 may also be maximized.

The extension surface 420c1 may extend obliquely to a rear side to be inclined to an upper side. An angle formed by the extension surface 420c1 and the first light output optical axis 300x1 may be smaller than an angle formed by the first light input optical axis 200x1 and the first light output optical axis 300x. The extension surface 420c1 may be exposed to an outside of the first optical module 10c1.

The third area 430c1 may extend from a front end of the first reflection area 411b to a lower side. For example, the third area 430c1 may extend perpendicular to the forward/rearward direction “A”. Furthermore, with respect to the forward/rearward direction “A”, the third area 430c1 may be disposed to face the first lower light output area 320c1. Furthermore, a width of the third area 430c1 in the upward/downward direction “H” may be the same as a width of the first lower light output area 320a in the upward/downward direction “H”.

Referring to FIG. 11, the second optical module 10c2 may form a hot zone of a low beam light distribution pattern. Meanwhile, the present disclosure is not limited to the example, and the second optical module 10c2 may form an entire low beam light distribution pattern.

The wide zone of the low beam light distribution pattern formed by the first optical module 10c1 and the hot zone of the low beam light distribution pattern formed by the second optical module 10c2 may overlap each other to form a low beam light distribution pattern.

The second optical module 10c2 may include a second light source 100c2, a second light input part 200c2, a second light output part 300c2, a second shield part 400c2, and a second guide part 500c2. For the description of each of the second light output part 300c2 and the second guide part 500a according to the third embodiment of the present disclosure, the description of the light output part 300a and the guide part 500a according to the first embodiment of the present disclosure is used.

The second light output part 300c2 may include a second upper light output area 310c2 and a second lower light output area 320c2. For the description of each of the second upper light output area 310c2 and the second lower light output area 320c2 according to the third embodiment of the present disclosure, the description of the upper light output area 310a and the lower light output area 320a according to the first embodiment is used.

The second light source optical axis 100x2 that is an optical axis of the second light source 100a may extend in parallel to the forward/rearward direction “A”. The second light source optical axis 100x2 may be parallel to the second light input optical axis 200x2 that is an optical axis of the second light input part 200c2. Furthermore, the second light source optical axis 100x2, the second light input optical axis 200x2, and the second light output optical axis 300x2 may be parallel to each other. The second light output optical axis 300x2 may mean an optical axis of the second light output part 300c2.

A diameter of the second light input part 200c2 may be different from a diameter of the first light input part 200c1. For example, the diameter of the first light input part 200c1 may be smaller than the diameter of the second light input part 200c2. The diameter of the first light input part 200c1 may mean a width of the first light input part 200c1 in a direction that is perpendicular to the first light input optical axis 200x1. Furthermore, the diameter of the second light input part 200c2 may mean a width of the second light input part 200c2 in a direction that is perpendicular to the second light input optical axis 200x.

The second light input part 200c2 may include a second light input central part 210c2 and a second light input outskirt part 220c2. A spacing distance between the second light input central part 210a and the second light source 100c2 may be named a second distance L2. For example, the second distance L2 may correspond to a depth of the second light input groove that is a light input groove of the second light input part 200c2.

The second light input groove may have a shape that is recessed to a front side on a rear side of the second light input part 200c2. The second light input groove may be a groove that is surrounded by an area, in which the light output from the second light source 100c2 of the second light input part 200c2 is input.

Furthermore, a diameter of the first light input groove may be smaller than a diameter of the second light input groove. For example, the diameter of the first light input groove may mean a width of the first light input groove in a direction that is perpendicular to the first light input optical axis 200x1. Furthermore, the diameter of the second light input groove may mean a width of the second light input groove in a direction that is perpendicular to the second light input optical axis 200x2.

Furthermore, a first brightness that is a maximum brightness (a maximum luminous intensity) of the light that passed through the first light input part 200c1 may be smaller than a second brightness that is a maximum brightness of the light that passed through the second light input part 200c2. Furthermore, the maximum brightness of the first optical module 10c1 may be smaller than the maximum brightness of the second optical module 10c2. Furthermore, an amount of the light output from the first optical module 10c1 may be greater than an amount of the light output from the second optical module 10c2. In this way, the second optical module 10c2 has a structure that may implement a high brightness with a small amount of light.

The brightness of the light that passed through the first light input part 200c1 may mean the number of, among the lights that passed through the first light input part 200c1, rays that exist within a unit solid angle range in a direction of a first light source optical axis 100x1. Furthermore, the brightness of the light that passed through the second light input part 200c2 may mean the number of, among the lights that passed through the second light input part 200c2, rays that exist within a unit solid angle range in a direction of the second light source optical axis 100x2.

Furthermore, the second distance L2 may be greater than the first distance L1. For example, as a difference between the second distance L2 and the first distance L1 increases, a difference between the second brightness and the first brightness may also increase. In other words, depending on a spacing distance between the light source and the light input outskirt part, the brightness of the light that passed through the light input part may be changed.

The second shield part 400c2 may include a first area 410c2, a second area 420c2, a third area 430c2, and a fourth area 440c2. For the description of each of the first area 410c2 and the second area 420c2 according to the third embodiment of the present disclosure, the description of the first area 410a and the second area 420a according to the first embodiment of the present disclosure may be used.

The third area 430c2 may extend from a front end of the second area 420c2 to a lower side. For example, the third area 430c2 may extend in parallel to the upward/downward direction “H”.

The fourth area 440c2 may extend obliquely to a rear side to be inclined from a lower end of the third area 430c2 to a lower side. A height of a lower end of the fourth area 440c2 in the upward/downward direction “H” may be the same as a height of a lower end of the second light output part 300c2 in the upward/downward direction “H”.

### Fourth Embodiment

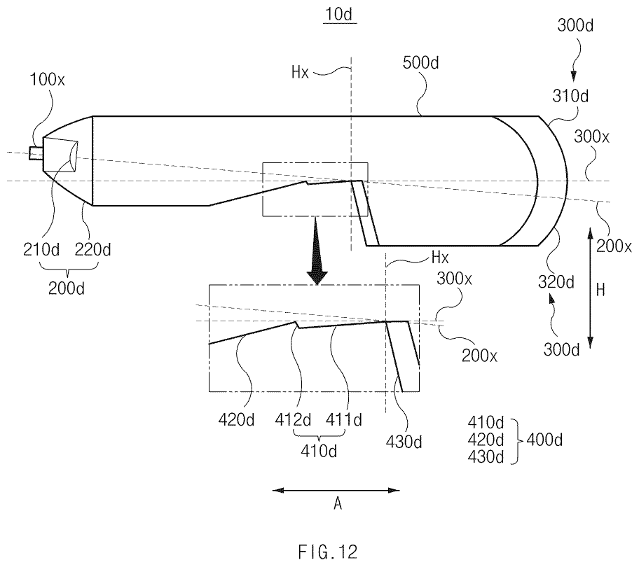

Hereinafter, a lamp 10d according to the fourth embodiment of the present disclosure will be described with reference to FIG. 12. In a description of the lamp 10d according to the fourth embodiment, a difference from the lamps according to the first to third embodiments of the present disclosure will be mainly described.

The lamp 10d according to the fourth embodiment of the present disclosure may include a light source 100d, a light input part 200d, a light output part 300d, a shield part 400d, and a guide part 500d. Meanwhile, for the description of the light source 100d, the light input part 200d, the light output part 300d, and the guide part 500d according to the fourth embodiment of the present disclosure, the description of the light source 100a, the light input part 200a, the light output part 300a, and the guide part 500a according to the first embodiment of the present disclosure is used.

The light input part 200d may include a light input central part 210d and a light input outskirt part 220d. Furthermore, the light output part 300d may include an upper light output area 310d and a lower light output area 320d. Meanwhile, for the description of the light input central part 210d, the light input outskirt part 220d, the upper light output area 310d, and the lower light output area 320d according to the fourth embodiment of the present disclosure, the description of the light input central part 210a, the light input outskirt part 220a, the upper light output area 310a, and the lower light output area 320a according to the first embodiment of the present disclosure is used.

The shield part 400d may include a first area 410d, a second area 420d, and a third area 430d. The first area 410d may have a shape that protrudes to a lower side. However, the present disclosure is not limited to the example, and the first area 410d may have a shape that is parallel to the light output optical axis 300x. The first area 410d may include a reflection area 411d and an extension area 412d.

The reflection area 411d may reflect any portion of the light that passed through the light input part 200d. The reflection area 411d may extend obliquely to a rear side to be inclined to a lower side with respect to the light output optical axis 300x. For example, a height of the front end of the reflection area 411d in the upward/downward direction “H” may be the same as a height of the light output optical axis 300x in the upward/downward direction “H”. Furthermore, a rear end of the reflection area 411d may be disposed on a lower side of the light output optical axis 300x.

The extension area 412d may extend from a rear end of the reflection area 411d to an upper side. For example, the extension area 412d may extend obliquely to an upper side to be inclined to a rear side. The extension area 412d may be connected to a front end of the second area 420d. In other words, the extension area 412d may extend obliquely between a front end of the second area 420d and a rear end of the reflection area 411d. A height of an upper end of the extension area 412d in the upward/downward direction “H” may be the same as a height of the light output optical axis 300x in the upward/downward direction “H”.

The second area 420d may prevent the light that passed through the light input part 200d from traveling to a front side. The second area 420d may be named ‘a light shielding area 420d’. The light shielding area 420d may be disposed on an upper side of a lower end of the light output part 300a.

The third area 430d may define a front side of the shield part 400d. The third area 430d may be named ‘a front area 430d’. Output reflected light may reach the front area 430d. The output reflected light may mean, among the lights that reached the light output part 300d, light that is reflected (as an example, totally reflected) from the light output part 300d and travels to a rear side.

The front area 430d may extend obliquely to a front side to be inclined to a lower side with respect to the light output optical axis 300x. For example, the front area 430d may extend obliquely to a front side from a front end of the reflection area 411d to be inclined to a lower side.

A height of an upper end of the front area 430d in the upward/downward direction may be the same as a height of the light output optical axis 300x in the upward/downward direction “H”. In other words, the upper end of the front area 430d may cross the light output optical axis 300x.

Furthermore, when the lamp 10d is viewed in the leftward/rightward direction, the front area 430d may have a shape of a straight line. For example, when the lamp 10d is viewed in the leftward/rightward direction, the front area 430d may have a diagonal shape extending to a front side and a lower side. When the lamp 10d is viewed in the leftward/rightward direction, the front area 430d may have a shape that is inclined to a front side with respect to an upward/downward reference line Hx. The upward/downward reference line Hx may be defined as an imaginary straight line that passes or extends through a front end of the reflection area 411d and extends in the upward/downward direction “H”.

In this way, because the front area 430d has a shape that is inclined to a front side with respect to the upward/downward reference line Hx, the output reflected light that reached the front area 430d may be totally reflected in the front area 430d and input of the output reflected light to the light output part 300d may be minimized. In this way, when the output reflected light is totally reflected in the front area 430d and the input to the light output part 300d is minimized, the output reflected light may be output from the light output part 300d whereby glare to the user may be minimized.

The output reflected light that reached the front area 430d may be output from the front area 430d. For example, the output reflected light may be refracted to an upper side when being output from the front area 430d. The light refracted and output from the front area 430d may be input to the first area 410d (e.g., the reflection area 411d). The light input to the first area 410d may pass through a first guide area, which will be described later, and may be output from an upper end of the guide part 500d.

The guide part 500d may include a first guide area and a second guide area. The first guide area may be disposed on an upper side of the reflection area 411d. The first guide area may mean an area that is located on an upper side of the guide part 500d with respect to the light output optical axis 300x.

The first guide area may extend from the upper light output area 310d to a rear side. A width of the first guide area in the upward/downward direction “H” may be the same as a width of the upper light output area 310a in the upward/downward direction “H”.

The second guide area may mean an area that is located on a lower side of the guide part 500d with respect to the light output optical axis 300x. The second guide area may guide travel of the output reflected light to a rear side. In other words, the second guide area may guide the light reflected from the light output part 300d to the front area 430d. The second guide area may extend in the forward/rearward direction “A” between the front area 430d and the lower light output area 320d.

### Fifth Embodiment

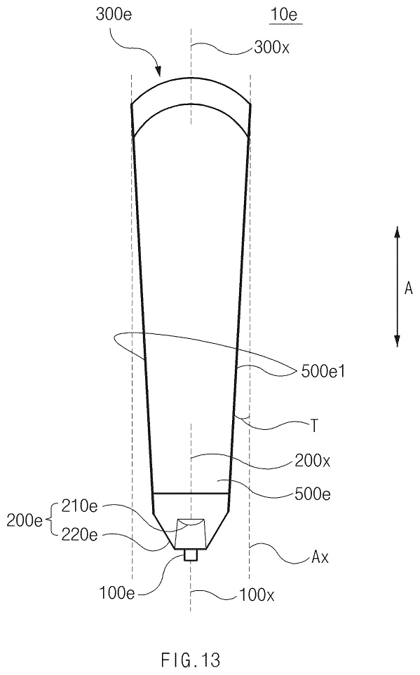

Hereinafter, a lamp 10e according to the fifth embodiment of the present disclosure will be described with reference to FIG. 13. In a description of the lamp 10e according to the fifth embodiment, a difference from the lamps according to the first to fourth embodiments of the present disclosure are mainly described.

The lamp 10e according to the fifth embodiment of the present disclosure may include a light source 100e, a light input part 200e, a light output part 300e, a shield part (not illustrated), and a guide part 500e. For the description of the light source 100e, the light input part 200e, the light output part 300e, and the shield part (not illustrated) according to the fifth embodiment of the present disclosure, the description of the light source 100a, the light input part 200a, the light output part 300a, and the shield part 400a according to the first embodiment of the present disclosure is used.

The light input part 200e may include a light input central part 210e and a light input outskirt part 220e. Furthermore, the light output part 300d may include an upper light output area and a lower light output area. Meanwhile, for the description of the light input central part 210e, the light input outskirt part 220e, the upper light output area, and the lower light output area according to the fifth embodiment of the present disclosure, the description of the light input central part 210a, the light input outskirt part 220a, the upper light output area 310a, and the lower light output area 320d according to the first embodiment of the present disclosure is used.

The guide part 500e may be divided into a plurality of areas with respect to the forward/rearward direction “A”. In at least some of the plurality of areas, a width of the first area in the leftward/rightward direction and a width of the second area in the leftward/rightward direction may be different from each other. For example, when the first area is located on a front side of the second area, a width of the first area in the leftward/rightward direction may be greater than a width of the second area in the leftward/rightward direction. In other words, in at least some of the plurality of areas, a width of the area relatively located on a front side in the leftward/rightward direction may be greater than a width of the area relatively located on a rear side in the leftward/rightward direction.

For example, the guide part 500e may have a shape, in which a width thereof in the leftward/rightward direction becomes smaller toward a rear side. On the left side and the right side of the guide part 500e, inclined surfaces 500e1 that extend obliquely to a rear side to be incline to an inside of the lamp 10e, respectively, may be formed. The inclined surfaces 500e1 may form a specific angle “T” with a forward/rearward reference line Ax. The forward/rearward reference line Ax may mean an imaginary straight line that extends in the forward/rearward direction “A”.

A width of the front end of the guide part 500e in the leftward/rightward direction may be the same as a width of the light output part 300e in the leftward/rightward direction. Furthermore, a width of the rear end of the guide part 500e in the leftward/rightward direction may be equal to or greater than a width of the light input part 200e in the leftward/rightward direction.

In an inclined surface 500e1, a portion of the light totally reflected by the light input outskirt part 220e may be reflected. For example, an angle formed by the inclined ray and the forward/rearward reference line Ax before the inclined ray reaches the inclined surface 500e1 may be greater than an angle formed by the inclined ray reflected by the inclined surface 500e1 and the forward/rearward reference line Ax. The inclined ray may mean one arbitrary ray of the light that is totally reflected by the light input outskirt part 220e.

When the inclined ray is reflected by the inclined surface 500e1, a degree of inclination of the inclined ray with respect to the forward/rearward reference line Ax may be reduced. In other words, when the inclined ray is reflected by the inclined surface 500e1, a degree of bending may be reduced. Accordingly, the inclined ray reflected by the inclined surface 500e1 may travel to be close to parallel to the forward/rearward direction “A”. In this way, when an inclination of the inclined ray with respect to the forward/rearward reference line Ax is reduced by the inclined surface 500e1, an amount of the light output from the light output part 300e may be maximized.

The inclined surface formed on a left side of the guide part 500e may be named ‘a left inclined surface’ or ‘a first inclined surface’. The first inclined surface may have a shape that extends to a rear side to be inclined to a right side. Furthermore, the first inclined surface may reflect a portion of the light totally reflected by the light input outskirt part 220e to a right side. For example, the first inclined surface may reflect a portion of the light totally reflected from a right side of the light input outskirt part 220e to a right side. After being reflected by the first inclined surface, the light output from the light output part 300e may form a right side of the wide zone.

Furthermore, the inclined surface formed on the right side of the guide part 500e may be named ‘a right inclined surface’ or ‘a second inclined surface’. The second inclined surface may have a shape that extends to a rear side to be inclined to a left side. Furthermore, the second inclined surface may reflect a portion of the light totally reflected by the light input outskirt part 220e to a left side. For example, the second inclined surface may reflect a portion of the light totally reflected from a left side of the light input outskirt part 220e to a left side. After being reflected from the second inclined surface, the light output from the light output part 300e may form a left side of the wide zone.

Furthermore, the left inclined surface and right inclined surface may have shapes that are symmetrical to each other with respect to a reference plane. The reference plane may be defined as an imaginary plane that is perpendicular to the leftward/rightward direction and passes or extends through a center of the lamp 10e (as an example, a center of the guide part 500e).

The lamp according to the present disclosure uses most of the light that passed through the primary optical system as the light for forming the light distribution pattern whereby a light output efficiency is improved.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A lamp comprising:
a first optical module configured to form a wide zone of a low beam light distribution pattern; and
a second optical module configured to form a hot zone of the low beam light distribution pattern having a luminous intensity higher than that of the wide zone,
wherein each of the first optical module and the second optical module includes:
a light source configured to output light;
a light input part configured to receive the light output from the light source;
a light output part configured to output the light passing through the light input part; and
a guide part disposed between the light input part and the light output part and configured to guide the light passing through the light input part to the light output part,
wherein the light input part of the first optical module is a first light input part, and the guide part of the first optical module is a first guide part,
wherein the light input part of the second optical module is a second light input part, and the guide part of the second optical module is a second guide part, and
wherein a shape of the first guide part on a side of the first light input part is different from that of the second guide part on a side of the second light input part.

2. The lamp of claim 1, wherein the first light input part has a diameter smaller than that of the second light input part.

3. The lamp of claim 1, wherein:
the first light input part has a first light input groove on a rear side of the first light input part,
the second light input part has a second light input groove on a rear side of the second light input part, and
the first light input groove has a diameter smaller than that of the second light input groove.

4. The lamp of claim 1, wherein:
the light output part of the first optical module is a first light output part,
an optical axis of the first light output part is first light output optical axis,
a lower end of the first light input part has a height equal to or greater than that of the first light output optical axis, and
a center of the first light input part is located between an upper end portion of the first light output part and the first light output optical axis.

5. The lamp of claim 4, wherein a first light input optical axis, which is an optical axis of the first light input part, is inclined with respect to the first light output optical axis, and extends through a focus of the light output part.

6. The lamp of claim 1, wherein:
the light output part of the first optical module is a first light output part, and
the first optical module includes:
a first reflection area disposed between the first light input part and the first light output part and configured to reflect a portion of the light passing through the first light input part; and
a first extension surface extending between a rear end of the first reflection area and a lower end of the first light input part.

7. The lamp of claim 6, wherein:
an optical axis of the first light input part is a first light input optical axis, and
the first extension surface extends from the rear end of the first reflection area to a rear side to be inclined with respect to the first light input optical axis.

8. The lamp of claim 7, wherein:
an optical axis of the first light output part is a first light output optical axis, and
an angle between the first light output optical axis and the first extension surface is smaller than that between the first light output optical axis and the first light input optical axis.

9. The lamp of claim 1, wherein:
an optical axis of the second light input part is a second light input optical axis,
the light output part of the second optical module is a second light output part,
an optical axis of the second light output part is a second light output optical axis, and
the second light input optical axis and the second light output optical axis are parallel to each other.

10. The lamp of claim 1, wherein:
the light output part of the second optical module is a second light output part,
an optical axis of the second light output part is a second light output optical axis, and
the second optical module further includes:
a second reflection area disposed between the second light input part and the second light output part and configured to reflect a portion of the light passing through the second light input part; and
a second extension surface extending between a rear end of the second reflection area and a lower end of the second light input part,
wherein the second extension surface extends diagonally with respect to the second light output optical axis and is disposed to overlap the second light input part.

11. The lamp of claim 1, wherein a maximum brightness of the light passing through the first light input part, is smaller than that of the light passing through the second light input part.

12. The lamp of claim 1, wherein:
the light source of the first optical module is a first light source, the light output part of the first optical module is a first light output part, and a first central light is a portion of light output from the first light source, the first light input part includes a first light input central part configured to refract the first central light such that the first central light travels toward a focus of the first light output part,
the light source of the second optical module is a second light source, the light output part of the second optical module is a second light output part, and a second central light is a portion of light output from the second light source,
the second light input part includes a second light input central part configured to refract the second central light such that the second central light travels toward a focus of the second light output part, and
a distance between the first light input central part and the first light source is smaller than that between the second light input central part and the second light source.
